(19) United States
(12) Patent Application Publication
(10) Pub. No.: US 2024/0059410 A1
(43) Pub. Date: Feb. 22, 2024

(54) DEVICE FOR PROPULSION IN A VEHICLE

(71) Applicant: Hugh Bryan Welcel, Winter park, FL (US)

(72) Inventor: Hugh Bryan Welcel, Winter park, FL (US)

(21) Appl. No.: 17/966,158

(22) Filed: Oct. 14, 2022

Related U.S. Application Data
(60) Provisional application No. 63/270,453, filed on Oct. 21, 2021.
(60) Provisional application No. 63/332,718, filed on Apr. 20, 2022.

(51) Int. Cl. B64C 29/00; B64D 27/24

(52) U.S. Cl. CPC B64C 29/0066; B64D 27/24

(57) ABSTRACT

The present disclosure provides a device for propulsion in a vehicle. The device comprises one or more inlets for allowing a fluid, one or more thrust sources provided for compress and accelerating the fluid, a group of dedicated or rotating exhaust strategic located in the vehicle and provided at a predetermined directions for generating the thrust in the predetermined direction to maneuver the vehicle, a system of ducts to distribute the compressed and accelerated fluid along the vehicle, from the thrust sources to the group of exhaust, an onboard computer and electronic controlled valves to regulate the fluid distributed individually to each exhaust.

### FIELD

The embodiments herein generally relate to an electric propulsion for a vehicle for adding different maneuvers capabilities to the vehicle. More particularly, the disclosure relates to an electric propulsion for the development of vertical take-off and landing or short take-off and landing (VTOL/STOL) capable flying vehicles.

### BACKGROUND AND PRIOR ART

A propulsion system is the most important part of a vehicle. The propulsion system is the thrust generator for moving the vehicle in a specific direction.

Currently, green energy sources, being environmentally friendly, are a preferred source of energy for the development of any type of vehicle. Electrical energy is the source with the greatest adaptation among users and developers, which also includes generation of electrical energy through processing of elements like hydrogen for charging a battery system or supplying direct energy to electrical motors or/and other devices.

For the development of flying vehicles, thrust is usually generated through the application of Newton's third law of action and reaction where a working fluid, is compressed and accelerated and the reaction produces a resulting force that is used to move the vehicle. There are many ways to compress and accelerate a working fluid, the most used devices used in this field to accomplish with this task are the combustion engines or electric motors through a wide variety of processes and mechanisms transform an energy source into a pushing force. The working fluid can be conducted with the use of duct to different places on the vehicle and delivered to ambient through exhaust nozzles strategic located in a desire direction. The working fluid and resulting force generate a reaction in the direction it was delivered to the ambient air, that can be used to move the vehicle. The working fluid can be increased or decreased with the use of control valves having a direct effect in the resulting force. The vehicle will move in the direction of the sum of all forces.

Presently, the propulsion system technology has become more efficient, with the introduction of stronger and lighter materials, additive manufacturing process, computer controller systems, the use of electric power sources and other alternative thrust sources. These advancements have enabled feasibility of the development of VTOL/STOL vehicles for usage not only for military purposes also for commercial purposes.

Therefore, there is a need for an improved and advanced propulsion system for imparting VTOL/STOL capabilities to a vehicle with better efficiency.

### Objects

Some of the objects of the present disclosure are described herein below:

The main objective of the present disclosure is to provide a device for propulsion in a vehicle for providing vertical take-off and landing and short take-off and landing capabilities to the vehicle.

Another objective of the present disclosure is to provide a device that is totally embedded in the vehicle body.

Still another objective of the present disclosure is to provide a device with a plurality of dedicated or rotating exhaust that can be mixed with the vehicle body geometry and used to move the vehicle in a desired direction.

Yet another objective of the present disclosure is to provide a device that uses one or more inlets strategic distributed in a vehicle to allowing a fluid that will be used to generate propulsion to a vehicle.

Still another objective of the present disclosure is to provide a device with one or more thrust source able to compress and accelerated a fluid to generate a pushing force.

The other objectives and advantages of the present disclosure will be apparent from the following description when read in conjunction with the accompanying drawings, which are incorporated for illustration of preferred embodiments of the present disclosure and are not intended to limit the scope thereof.

### SUMMARY

In view of the foregoing, an embodiment herein provides a device for propulsion in a vehicle. In accordance with an embodiment, the device comprises one or more inlet for allowing a fluid, one or more thrust sources provided for accelerating the fluid, a plurality of dedicated or rotating exhaust strategic located in the vehicle and provided at a predetermined directions for generating the thrust in the predetermined direction to maneuver the vehicle, a system of ducts to distribute the compressed and accelerated fluid along the vehicle, from the thrust sources to the group of exhaust, an onboard computer and electronic controlled valves to regulate the fluid distributed individually to each exhaust nozzle.

In an embodiment, an exhaust can be fixed in a predetermined direction, the working fluid and resulting force will be delivered to ambient in the direction of the exhaust, a rotative type exhaust nozzle can be used to delivery the working fluid and resulting force in different directions according flight stage.

In an embodiment, each exhaust works individually from each other, making possible to use some exhaust for a flight stage and others for other flight stage or to change the direction of the vehicle.

In accordance with an embodiment, a group of exhaust can be provided in a direction to generate vertical thrust forces for vertical flight and another group to generate horizontal forces for forward flight.

In accordance with an embodiment, the exhaust can be provided with different kinds of vector thrust mechanism to redirect the working fluid and resulting force in a desired direction.

In accordance with an embodiment, exhaust can be designed to apply different multi phenomena and aerodynamic effect in a vehicle, making possible to replace flaps and ailerons function in an aircraft.

In accordance with an embodiment, the exhaust system can be provided with different kinds of nozzles including of variable or special geometry as aerospike nozzles, to optimize the performance of the vehicle in specific flight stages.

In accordance with an embodiment, the device instead of providing a direct exhaust of fluid to ambient can be connected to a plurality of external fluidic thrusters strategic located to provide propulsion to the vehicle.

In accordance with an embodiment, the device can use a mix configuration of exhausts strategic located together with a plurality of external strategic located fluidic thrusters fed by the device.

In accordance with an embodiment, the device can be provided with an optional pressure tank that can be used as reservoir and to help regulate air pressure of the device.

In accordance with an embodiment, the thrust sources, can be of different kinds like radial, centrifugal or mix kind electric driven air compressors, any other novel electric thrust source that can compress and accelerate a fluid and meet requirements of the device, can be used.

In accordance with an embodiment, the device is not limited to the use of electric thrust sources, can use fossil fueled thrust sources or hybrid technology.

In accordance with an embodiment, the device is full embedded into vehicle body, different insulating materials can be used in the enclosure to reduce noise and thermal emissions.

In accordance with an embodiment, the device uses an onboard computer to control electronic valves that will regulate the working fluid individually in each exhaust, increasing and decreasing the working fluid to change the resulting force as required in the flight stage and to produce the movement of the vehicle in a desired direction.

In accordance with an embodiment, the duct system geometry is designed to conduct the working fluid from the thrust sources to exhaust nozzles, with a smooth geometry to allow low power lose amounts.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF DRAWINGS

The detailed description is set forth with reference to the accompanying figures. In the figures, the left-most digit(s) of a reference number identifies the figure in which the reference number first appears. The use of the same reference numbers in different figures indicates similar or identical items.

FIG. 1a illustrates a perspective view of a device provided with strategic located exhausts without nozzles, to provide vertical and horizontal thrust and with an optional pressure tank, according to an embodiment herein;

FIG. 1b illustrates a perspective view of a device provided with strategic located exhausts with nozzles, to provide vertical and horizontal thrust and with an optional pressure tank, according to an embodiment herein;

FIG. 1c illustrates a perspective view of a device provided with strategic located exhaust with nozzles at front and rear, to provide vertical and horizontal thrust and with an optional pressure tank, according to an embodiment herein;

FIG. 2a illustrates a perspective view of a device provided with fluidic thrusters at front and rear, and with an optional pressure tank, according to an embodiment herein;

FIG. 2b illustrates a perspective view of a device provided with fluidic thrusters at front and rear, and with an optional pressure tank, according to an embodiment herein;

FIG. 2c illustrates a perspective view of a device provided with a fluidic thruster at front and dedicated exhaust with nozzles at rear and with an optional pressure tank, according to an embodiment herein;

FIG. 3a illustrates a perspective view of a flying vehicle with devices provided with dedicated strategic located in the vehicle, to provide vertical and horizontal thrust, according to an embodiment herein;

FIG. 4a illustrates a perspective view of a flying vehicle with a mix of external fluidic thrusters at front and dedicated exhaust at rear, according to an embodiment herein;

FIG. 4b illustrates a perspective view of a device able to provide propulsion to a vehicle with a mix of external fluidic thrusters at front and dedicated exhaust at rear, according to an embodiment herein;

FIG. 5a illustrates a sectional view of an exhaust with integrated flap mechanism providing horizontal thrust, according to another embodiment herein;

FIG. 5b illustrates a sectional view of an exhaust with integrated flap mechanism providing vertical thrust, according to another embodiment herein;

FIG. 6a illustrates a perspective sectional view of an exhaust with integrated bucket mechanism providing horizontal thrust, according to another embodiment herein;

FIG. 6b illustrates a sectional view of an exhaust with integrated bucket mechanism providing vertical thrust, according to another embodiment herein;

FIG. 7a illustrates a perspective sectional view of an exhaust with integrated ventral flap mechanism providing horizontal thrust, according to another embodiment herein;

FIG. 7b illustrates a sectional view of an exhaust with integrated ventral flap mechanism providing vertical thrust, according to another embodiment herein;

FIG. 8a illustrates a sectional view of an exhaust with integrated single swivel elbow mechanism providing horizontal thrust, according to another embodiment herein;

FIG. 8b illustrates a sectional view of an exhaust with integrated single swivel elbow mechanism providing vertical thrust, according to another embodiment herein;

FIG. 9a illustrates a side sectional view of an exhaust with a vector thrust cascade vanes mechanism providing horizontal thrust, according to another embodiment herein;

FIG. 9b illustrates a side sectional view of an exhaust with a vector thrust cascade vanes mechanism providing vertical thrust, according to another embodiment herein;

FIG. 10a illustrates a side sectional view of a flexible duct with a bending mechanism, bending the duct, to provide vertical thrust, according to another embodiment herein;

### DETAILED DESCRIPTION OF THE PREFERRED EMBODIMENTS

The embodiments herein and the various features and advantageous details thereof are explained more fully with reference to the non-limiting embodiments and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

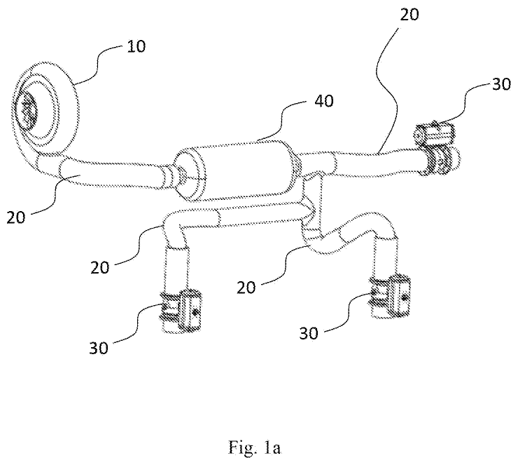

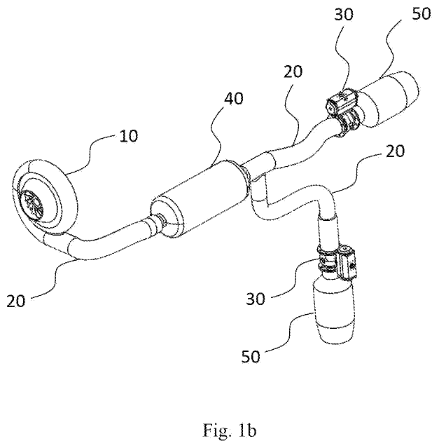

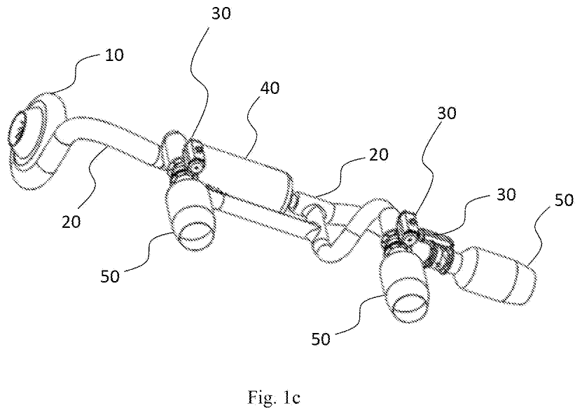

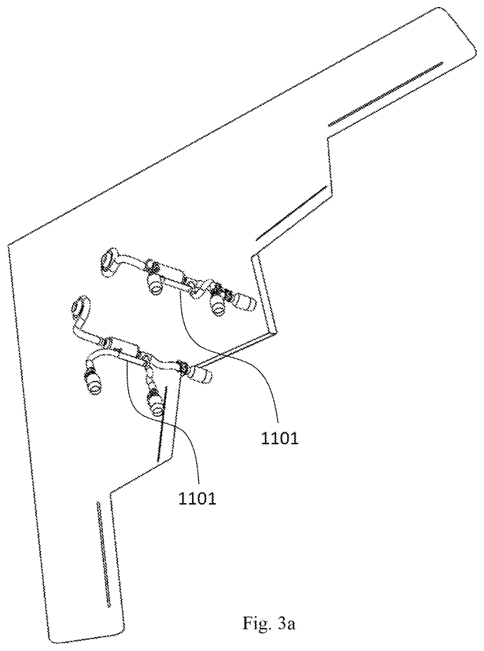

As mentioned above, there is a need for an improved and advanced propulsion system. In particular, there is a need for an embedded propulsion system with exhaust strategic located in the vehicle and mixed with vehicle geometry able to provide VTOL/STOL capabilities to a vehicle with better efficiency. The embodiments herein achieve this by providing “An airflow device for propulsion in a vehicle”. Referring now to the drawings, and more particularly to FIG. 1 through FIG. 4, where similar reference characters denote corresponding features consistently throughout the figures, there are shown preferred embodiments.

In an embodiment, a device for propulsion is provided in a vehicle. The device for propulsion includes one or more inlets for allowing a fluid, one or more thrust sources provided for compress and accelerating the fluid, a plurality of dedicated or rotating exhaust strategic located in the vehicle and provided at a predetermined directions for generating the thrust in the predetermined direction to maneuver the vehicle, a system of ducts to distribute the compressed and accelerated fluid along the vehicle, from the thrust sources to the group of exhaust, an onboard computer and electronic controlled valves to regulate the fluid distributed individually to each exhaust. The exhaust located at predetermined direction including but not limited to vertical and horizontal. Exhaust can be provided with a variety of nozzles to optimize the thrust according flight stage or vector thrust mechanism to allow the redirection of thrust. The control valves increase or decrease the working fluid to each exhaust individually making possible to distribute the pushing forces in a desired direction. The onboard computer makes possible to control the electronic valves individually.

In an embodiment, the ducts geometry is designed to allow low loss of power and provide an efficient conduction of the working fluid along the vehicle from thrust sources to exhaust.

In an embodiment, the device as configures can be full embedded in a vehicle body, the enclosure can be provided with insulting noise and thermal materials, reducing noise levels and thermal emissions significatively.

FIG. 1a, FIG. 1b, FIG. and 1c, illustrate a perspective view of a device. In an embodiment, one or more inlets for allowing a fluid, one or more thrust sources provided for compress and accelerating the fluid, a group of dedicated or rotating exhaust strategic located in the vehicle and provided at a predetermined directions for generating the thrust in the predetermined direction to maneuver the vehicle, a system of ducts to distribute the compressed and accelerated fluid along the vehicle, from the thrust sources to the group of exhaust, an onboard computer and electronic controlled valves to regulate the fluid distributed individually to each exhaust. In an embodiment, the device, can be provided with an optional pressure tank to regulate the pressure of the system and as reservoir, the exhaust can be provided with different kinds of nozzles to optimize the performance at different flight stages, reduce the noise and provide the device with other additional features.

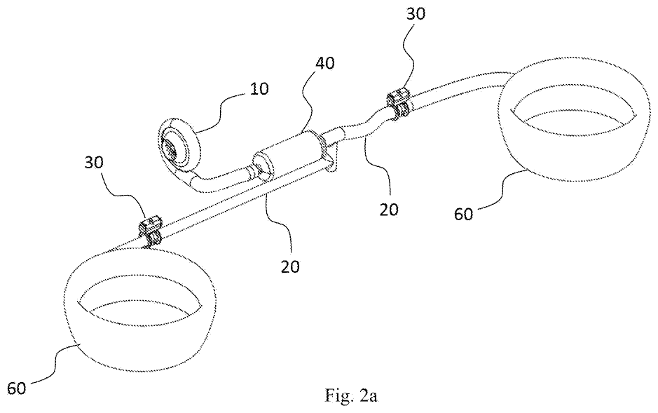

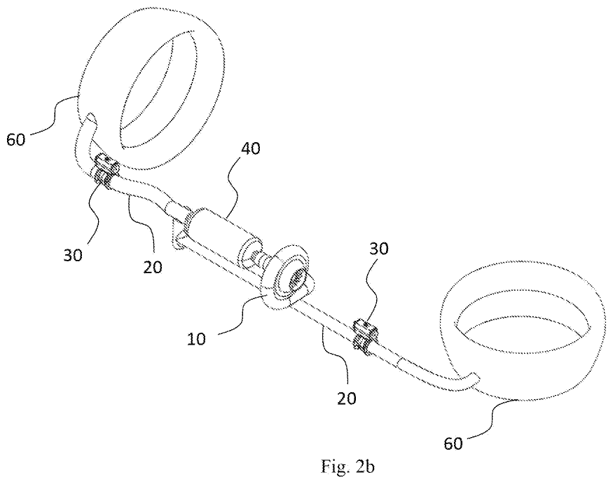

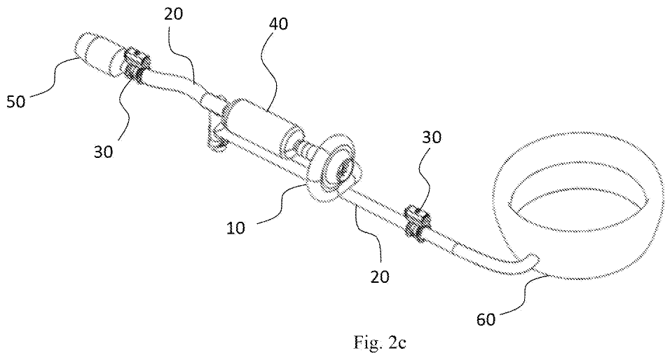

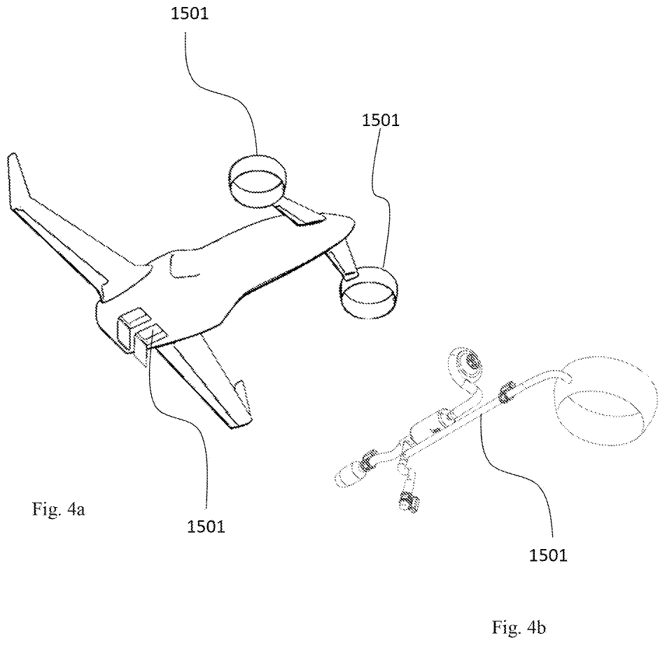

FIGS. 2a, 2b, 4a and 4b, illustrate a perspective view of a device feeding external fluidic thruster or a mix of fluidic thrusters and dedicated exhausts, strategic located in the vehicle to provide horizontal and vertical thrust.

In an embodiment, the device can be used to fed fluidic thrusters, the thrust sources are able to produce the required working fluid to make fluidic thrusters generate thrust to move a vehicle in a desired direction.

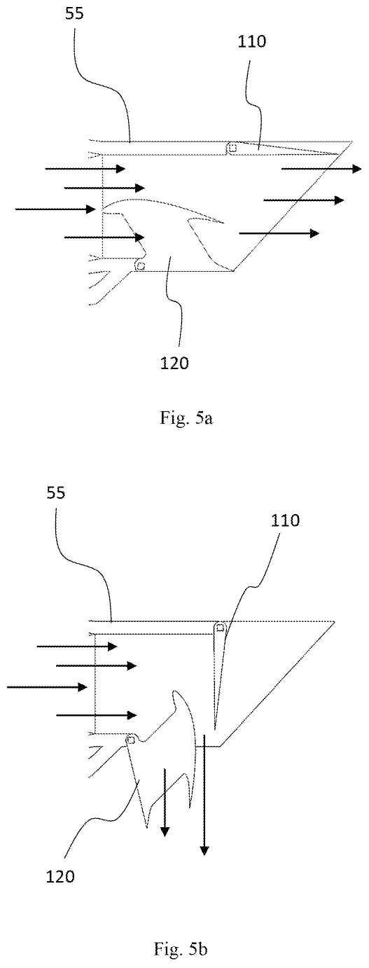

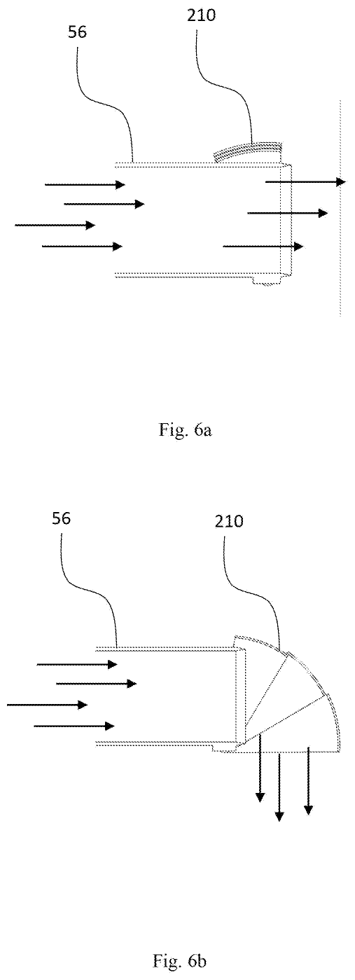

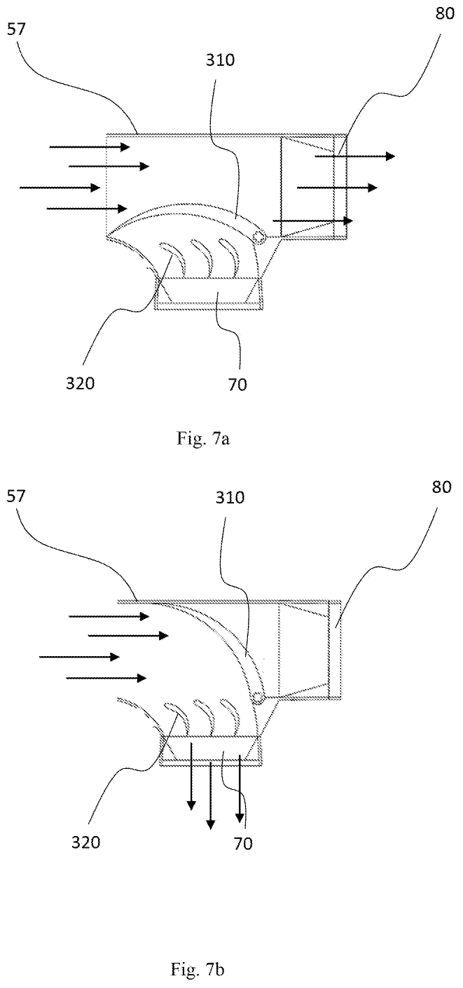

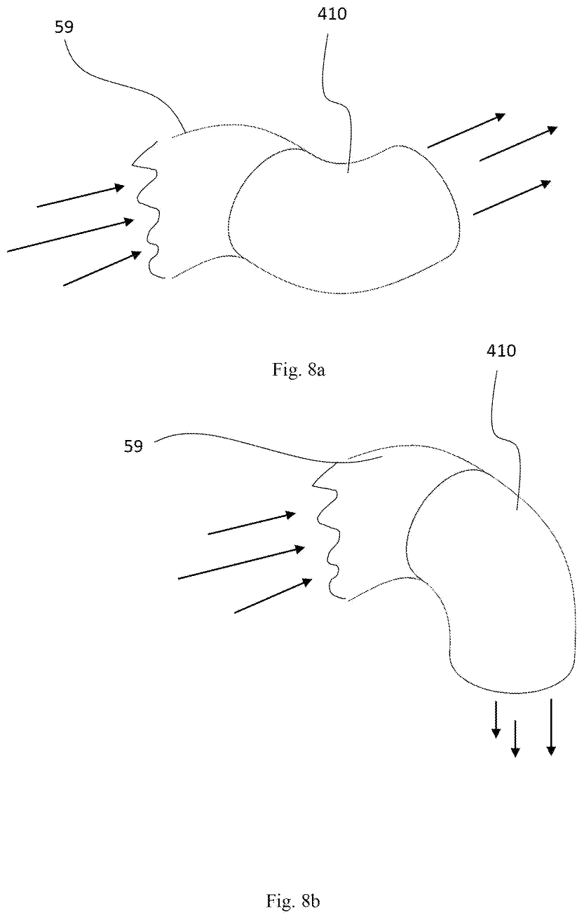

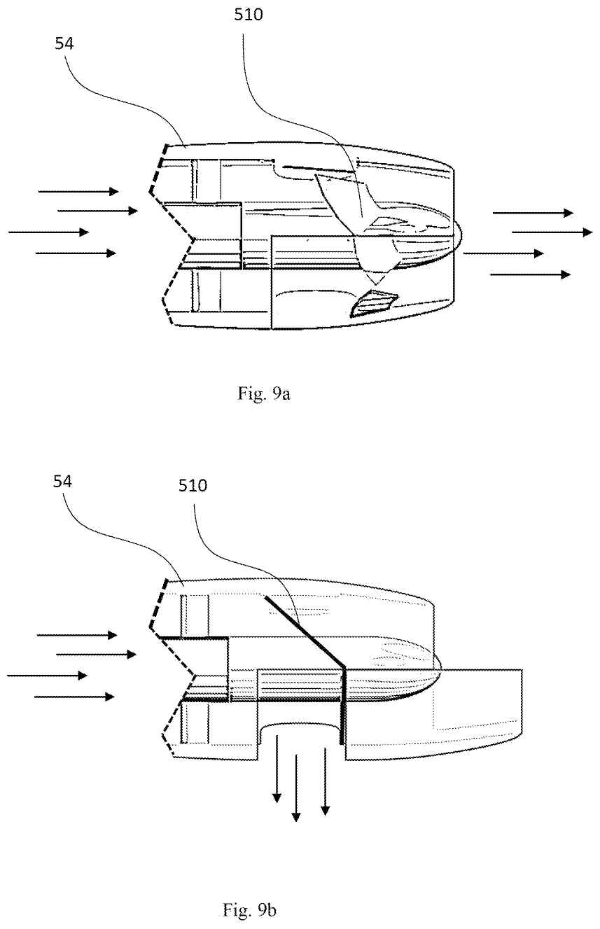

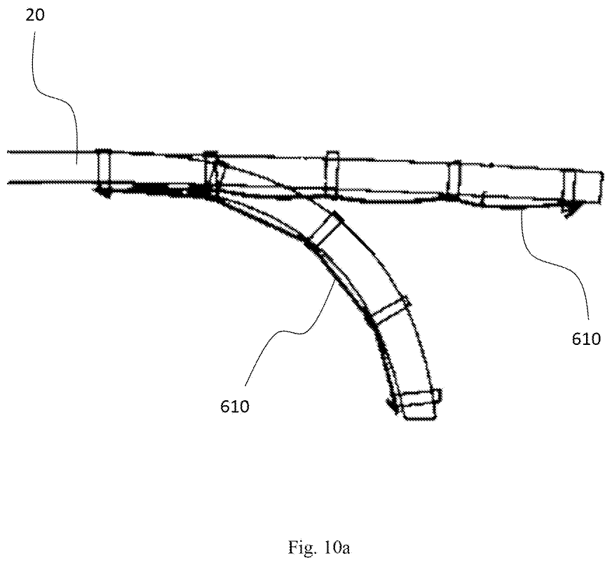

FIG. 5a, FIG. 5b, FIG. 6a, FIG. 6b, 7a, 7b, 8a, 8b, 9a, 9b and 10a, illustrate side views of exhaust with vector thrust and bending mechanisms, to redirect the working fluid and resulting force from a direction to another, making possible to move a vehicle in multiple directions according flight stage.

A main advantage of the present disclosure is that the device for propulsion provides VTOL/STOL capabilities to the vehicle.

Another advantage of the present disclosure is that the device is located full embedded into a vehicle.

Still another advantage of the present disclosure is that the enclosure together with isolating noise and thermal material, reduce noise levels and thermal emission significatively.

Yet another advantage of the present disclosure is that the device can be customized with different nozzles kind of nozzle to optimize the performance and add features in different flight stages.

Still another advantage of the present disclosure is that the device can be adapted easily to the vehicle design, making possible more clean and more aerodynamic designs.

Yet another advantage of the present disclosure is that the device can feed fluidic thrusters, a bladeless novel propulsion able to provide pushing forces to move a vehicle with efficiency.

Still another advantage of the present disclosure is that the device providing propulsion with better efficiency, minimum power loss.

Still another advantage of the present disclosure is that the device for propulsion provides a simpler design for ease of usage with a vehicle.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

Dated this 9 Sep. 2021

I claim:

1. A device for propulsion in a vehicle, comprising:
One or more inlets strategic distributed along the vehicle for allowing a fluid;
One or more thrust sources provided for compress and accelerating the fluid (working fluid);
a plurality of dedicated or rotating exhausts mixed with the vehicle geometry and strategic distributed along the vehicle and in a predetermined direction to delivery the working fluid to ambient and the resulting force to provide vertical and horizontal thrust as required by flight stage.
Exhausts able to work individually form each other and provided with nozzles of different kind to optimize performance and add features in some flight stages.
Exhaust able to be provided with vector thrust mechanism to redirect the delivery of working fluid and resulting force in a desired direction to provide movement to a vehicle.
A duct system to conduct the working fluid form thrust sources to exhausts.
A flexible duct system able to be provided with a bending system to redirect the delivery of working fluid to ambient and resulting force to provide movement to a vehicle.
An optional pressure tank to optimize system pressure and as reservoir for for unforeseen situations.
An onboard computer provided with multiple sensors to control electronics valves.
Electronic valves to increase and decrease the working fluid and resulting force in each exhaust.

2. The device as claimed in claim 1, wherein the device is able to provide vertical or short take off and landing (VTOL/STOL) capabilities to a vehicle.

3. The device as claimed in claim 1, wherein the device can be full embedded into a vehicle body and the enclosure provided with insulating noise and thermal materials.

4. The device as claimed in claim 1, wherein the thrust source can be an air compressor or another kind of thrust source able to compress and accelerate a fluid.

5. The device as claimed in claim 1, wherein the thrust source can be driven by an electric motor or other different electric or non-electric source including fossil fuel use or hybrid technology.

6. The device as claimed in claim 1, wherein the exhaust can be fixed and dedicated to deliver the working fluid and resulting force in a predetermined direction, providing vertical and horizontal thrust to move a vehicle.

7. The device as claimed in claim 1, wherein the exhausts can be rotative type and provided with vector thrust mechanism like flap, ventral flap, cascade, bucket and many others without limitation, to redirect the working fluid direction and resulting force to a desired direction to move a vehicle.

8. The device as claimed in claim 1, wherein the exhausts can be provided with different kinds of nozzles like noise suppressor, variable geometry, aerospike, etc., to optimize the performance of the device or add a feature.

9. The device as claimed in claim 1, wherein the onboard computer is able to control with the use of multiple sensor and y the management of electronic valves, the working fluid distribution of the device and the delivery of it in each exhaust, increasing and decreasing the working fluid and resulting force as required by the vehicle and the flight stage.

10. The device as claimed in claim 1, wherein the onboard computer is provided with duplicated critical components to ensure redundancy in case of failure of one of them.

11. The device as claimed in claim 1, wherein electronic valves controlled by an onboard computer are provided to increase and decrease the delivery to the ambient of the working fluid and resulting force in each exhaust, making possible to generate the amount of thrust required by the vehicle by exhaust to move it in a predetermined direction.

12. The device as claimed in claim 1, wherein the electronic valves are provided with duplicated critical components to ensure redundancy in case of failure of one of them.
The device as claimed in claim 1, wherein the duct system is designed and calculated to allow a low power lose due conducting the working fluid from the thrust sources to exhausts.
